(19) United States
(12) Patent Application Publication
(10) Pub. No.: US 2022/0317233 A1
(43) Pub. Date: Oct. 6, 2022

(54) System and Method of Detecting and Notifying of an Occurrence of an Overboard Passenger on a Vessel

(71) Applicant: Christopher Michael Alexander Verlinden, Clarksburg, MD (US)

(72) Inventor: Christopher Michael Alexander Verlinden, Clarksburg, MD (US)

(21) Appl. No.: 17/836,908

(22) Filed: Jun. 9, 2022

Related U.S. Application Data
(63) Continuation-in-part of application No. 16/734,076, filed on Jan. 3, 2020, now Pat. No. 11,380,975.
Application No. 16/734,076 is a continuation-in-part of application No. 16/734,116, filed on Jan. 3, 2020, now Pat. No. 11,380,976.
(60) Provisional application No. 62/788,080, filed on Jan. 3, 2019.
(60) Provisional application No. 62/788,080, filed on Jan. 3, 2019.

(51) Int. Cl. G01S 5/02; B63C 9/00; B63C 9/01; B63C 9/20; B64C 39/02

(52) U.S. Cl. CPC G01S 5/0231; B63C 9/0005; B63C 9/01; B63C 9/20; B64C 39/024; B64C 2201/022; B64C 2201/128; B64C 2201/141; B64C 2201/205

(57) ABSTRACT

A system and a method of detecting and notifying of an occurrence of an overboard passenger on a vessel are used to automatically and immediately track and locate the overboard passenger as soon as the passenger has fallen overboard. In order to accomplish this, the method uses at least one tracking beacon and at least one central computing device. The central computing device is mounted onto a water-faring vessel to passively track the status and location of the tracking beacon so that the central computing device can automatically locate the tracking beacon once an overboard occurrence is detected. The tracking beacon utilizes spatial-positioning and orientation data and water submersion data to transmit an emergency alert when the passenger wearing the tracking beacon falls overboard from the water-faring vessel. Once the emergency alert is received, the central computing device executes a rescue response to expedite the rescue of the overboard passenger.

The current application is a continuation-in-part (CIP) application of a U.S. non-provisional application Ser. No. 16/734,076 filed on Jan. 3, 2020. The U.S. non-provisional application Ser. No. 16/734,076 a claims a priority to a U.S. provisional application Ser. No. 62/788,080 filed on Jan. 3, 2019.

The current application is also a CIP application of a U.S. non-provisional application Ser. No. 16/734,116 filed on Jan. 3, 2020. The U.S. non-provisional application Ser. No. 16/734,116 also claims a priority to the U.S. provisional application Ser. No. 62/788,080 filed on Jan. 3, 2019.

### FIELD OF THE INVENTION

The present invention relates generally to systems and methods for long-range tracking and location. More specifically, the present invention provides a system and a method of detecting when a passenger on a vessel has fallen overboard and of executing an automatic rescue response that facilitates the immediate tracking and locating of the overboard passenger.

### BACKGROUND OF THE INVENTION

Locating individuals once separated from a marine vessel in large bodies of water is perhaps one of the greatest challenges in maritime Search and Rescue (SAR). Personal Flotation Devices (PFDs) are generally required to be carried by marine vessels with equipment specifications often regulated by a federal government. Most PFDs make it possible for People in the Water (PIWs) to remain afloat for extended periods of time; however, PFDs do not significantly reduce the challenges associated with locating PIWs. For example, while many PFDs are designed to provide some visibility to facilitate the tracking of PIWs, the visibility provided by currently available PFDs is limited and oftentimes useless due to many variables, such as weather, poor illumination, etc. Nowadays, various location and tracking technologies have been provided. Many of these technologies such as Global Positioning Systems (GPS) allow for remote tracking of people and objects. However, implementing these technologies on PFDs is often expensive and unpractical due to the large amounts of PFDs required to be present on marine vessels and the extensive maintenance some of these technologies require. Therefore, there is a need for a system and method that facilitates the tracking of PIWs for the efficient rescue of the PIWs.

### SUMMARY OF THE INVENTION

The present invention provides simple, inexpensive means of tracking and rescuing passengers who have fallen overboard from a vessel. The system of the present invention utilizes passive, long-range radio devices capable of transmitting an emergency alert in various radio frequencies, such as two to four Megahertz (MHz) (S-band) or eight to twelve MHz (X-band), when interrogated by a marine surface search radar or similar tracking device. These devices are meant to be attached to Personal Flotation Devices (PFDs) and Type IV throwable flotation devices so that the passenger wearing the devices can be readily tracked for immediate rescue purposes. Thus, the present invention allows for easy detection of PIWs by standard marine radars.

The present invention enables the automatic tracking and locating of overboard passengers by implementing a passive alert system that is triggered when specific criteria is met. The criteria correspond to different factors that change while the passenger is falling overboard. Once the passenger has been detected overboard, the appropriate parties are notified, and an automatic rescue response is executed which deploys various autonomous vehicles to track the location of the overboard passenger. Once the overboard passenger has been located by the various autonomous vehicles, the autonomous vehicles accompany the overboard passenger until the rescue parties get to the overboard passenger. Thus, the present invention ensures any overboard passenger is promptly found under any weather condition. Additional features and benefits of the present invention are further discussed in the sections below.

### BRIEF DESCRIPTION OF THE DRAWINGS

FIG. 1 is a schematic view showing the overall system of the present invention.

FIG. 2 is a schematic view showing the tracking beacon and the central computing device of the system of the present invention, wherein the tracking beacon is shown in a hardwired configuration.

FIG. 3 is a schematic view showing the tracking beacon and the central computing device of the system of the present invention, wherein the tracking beacon is shown in a wireless configuration.

FIG. 4 is a schematic view showing the unmanned vehicle and the computerized marking buoy of the system of the present invention.

FIG. 5 is a flowchart depicting the overall process of the present invention.

FIG. 6 is a flowchart depicting the subprocess for validating the overboard status of the tracking beacon using an inertial measurement unit and a hydrostatic sensor.

FIG. 7 is a flowchart depicting the subprocess for improving the location tracking accuracy of the tracking beacon using location tracking module.

FIG. 8 is a flowchart depicting the subprocess for transmitting an emergency alert via as a radio signal.

FIG. 9 is a flowchart depicting the subprocess for deploying the unmanned vehicle and the computerized marking buoy during a rescue response.

FIG. 10 is a flowchart depicting the subprocess for activating a vehicle illumination source of the unmanned vehicle.

FIG. 11 is a flowchart depicting the subprocess for transmitting the emergency alert from the unmanned vehicle using a vehicle radio transmitter.

FIG. 12 is a flowchart depicting the subprocess for activating a buoy illumination source of the computerized marking buoy.

FIG. 13 is a flowchart depicting the subprocess for transmitting the emergency alert from the computerized marking buoy using a buoy radio transmitter.

### DETAIL DESCRIPTIONS OF THE INVENTION

All illustrations of the drawings are for the purpose of describing selected versions of the present invention and are not intended to limit the scope of the present invention.

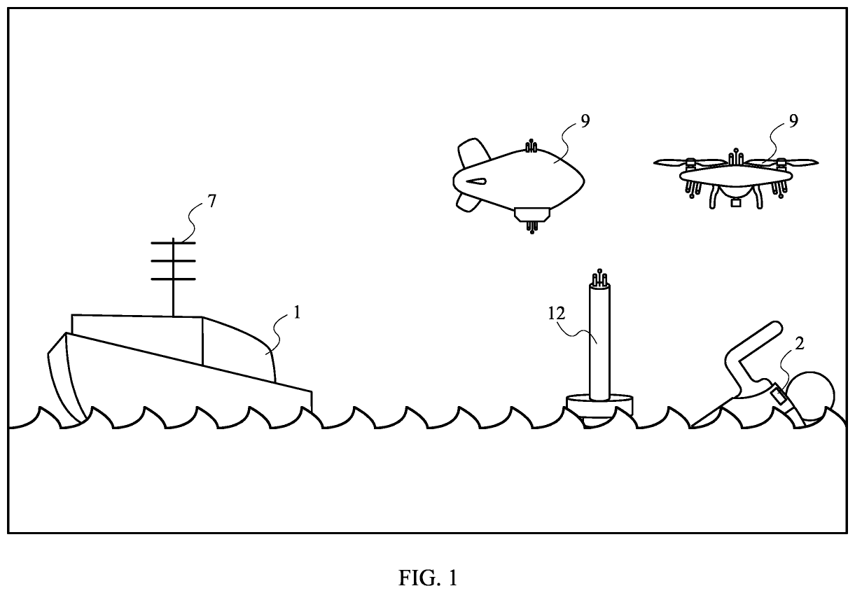

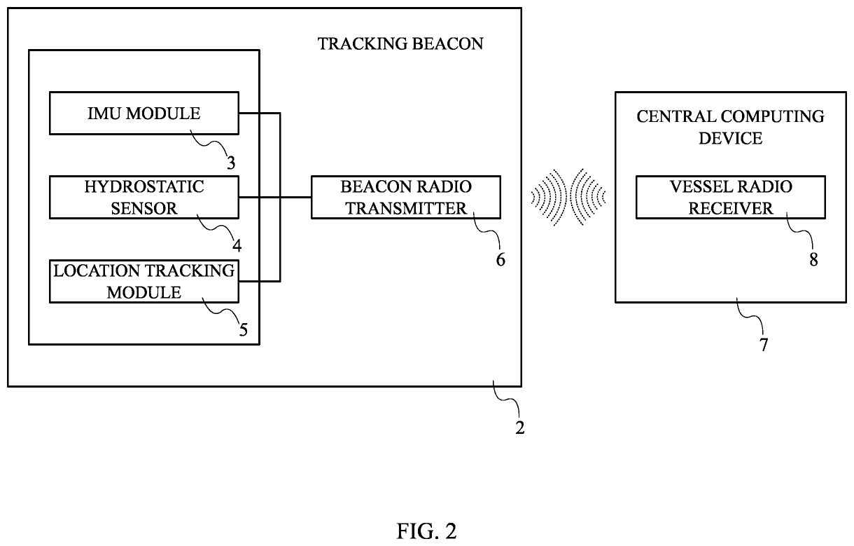

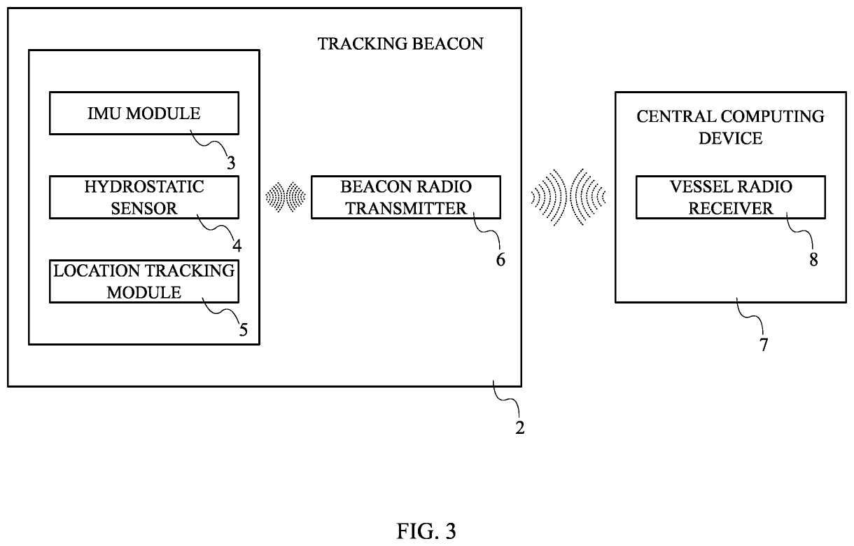

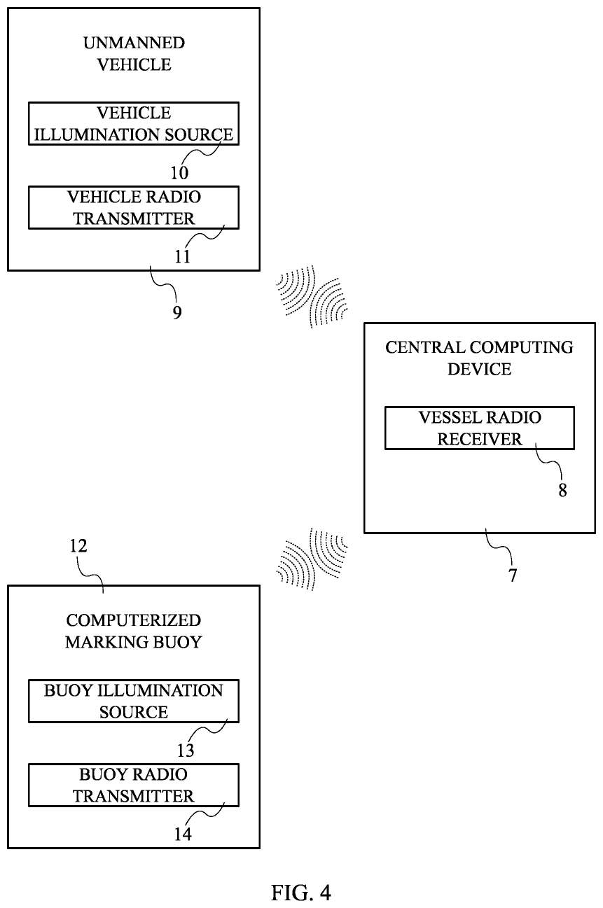

The present invention is a system and a method of detecting and notifying of an occurrence of an overboard passenger on a vessel. The present invention enables the automatic and immediate tracking and locating of the passenger as soon as the passenger has fallen overboard. As can be seen in FIG. 1 through 4, the system used to implement the method of the present invention is provided with a water-faring vessel 1, at least one tracking beacon 2, and at least one central computing device 7 (Step A). The central computing device 7 is mounted onto the water-faring vessel 1 to enable the automatic tracking and locating of the tracking beacon 2. The tracking beacon 2 can transmit radio signals that are picked up by the central computing device 7 to passively keep track of the status and location of the tracking beacon 2. The tracking beacon 2 is worn by the passenger so that the status and location of the passenger can be determined using the central computing device 7. The signal generated by the tracking beacon 2 is strong enough that the central computing device 7 can determine the status of the tracking beacon 2 onboard the water-faring vessel 1 and overboard the water-faring vessel 1. Multiple units of the tracking beacon 2 can be provided to match the number of people in the water-faring vessel 1. This way, all the passengers and the staff in the water-faring vessel 1 can be promptly rescued.

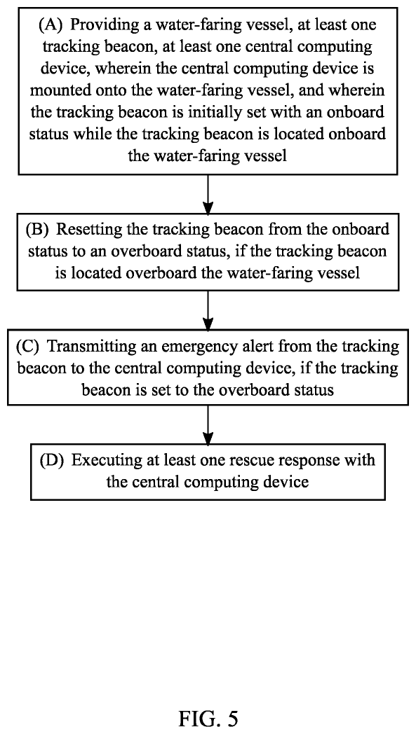

The overall process followed by the method of the present invention allows staff and emergency and rescue services to be promptly deployed and accurately guided to a passenger who has fallen overboard. As can be seen in FIG. 5, the overall process begins by initially setting the tracking beacon 2 with onboard status while the tracking beacon 2 is located onboard the water-faring vessel 1 (Step A). The onboard status remains while the passenger wearing the tracking device stays onboard the water-faring vessel 1. If the tracking device is located overboard the water-faring vessel 1 while the water-faring vessel 1 is in the water, the tracking beacon 2 is reset from the onboard status to an overboard status (Step B). By resetting the tracking beacon 2 to the overboard status, the tracking beacon 2 can start the appropriate rescue protocols. Firstly, an emergency alert from the tracking beacon 2 is transmitted to the central computing device 7 after the tracking beacon 2 has been set to the overboard status (Step C). Then, at least one rescue response is executed with the central computing device 7 (Step D). The at least one rescue response can be a manned or automatic rescue operation to help the overboard passenger. The emergency alert not only prompts the computing device to execute the prompt rescue response but also notifies all appropriate parties that the passenger has fallen overboard.

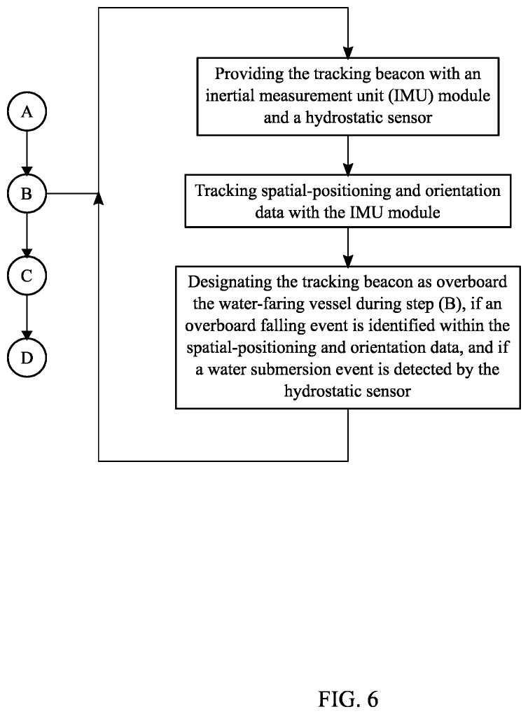

As previously discussed, the present invention enables the passive locating of the tracking beacon 2. This enables the present invention to analyze possible false alarms from the tracking beacon 2 in order to not execute the rescue protocols unnecessarily (Steps C and D). As can be seen in FIGS. 1 through 3 and 6, to do so, the tracking beacon 2 is provided with an inertial measurement unit (IMU) module 3 and a hydrostatic sensor 4. The IMU module 3 enables the tracking of the location and positioning of the tracking beacon 2 without the need of external tracking systems. The hydrostatic sensor 4 helps determine if the tracking beacon 2 is submerged in water. By keeping track of the spatial-positioning orientation, and the level of submergence of the tracking beacon 2, the central computing device 7 can determine if the emergency alert is a false alert or a valid alert. To distinguishing a false alarm from a valid alarm, the subprocess involves tracking spatial-positioning and orientation data with the IMU module 3. Tracking the spatial-positioning and orientation data of the tracking beacon 2 enables the central computing device 7 to locate the tracking beacon 2 in relation to the water-faring vessel 1 as well as the relative motion of the tracking beacon 2 in relation to the water-faring vessel 1. Then, using the data form the IMU module 3, the tracking beacon 2 is designated as overboard the water-faring vessel 1 during Step B, if an overboard falling event is identified within the spatial-positioning and orientation data, and if a water submersion event is detected by the hydrostatic sensor 4. The overboard falling event is preferably identified when the passenger wearing the tracking beacon 2 falls off the ship. The sudden acceleration of the tracking beacon 2 and the spatial-positioning of the tracking beacon 2 outside the perimeter of the water-faring vessel 1 are determined from the spatial-positioning and orientation data. Further, the water submersion event is identified after the passenger wearing the tracking beacon 2 falls into the water. The water submersion event is determined by a water detection reading from the underwater submersion of the hydrostatic sensor 4. Thus, the tracking beacon 2 is reset to an overboard status only if the passenger wearing the tracking beacon 2 falls off the ship and into the water. Furthermore, in case the passenger gets off the water-faring vessel 1 for any reason (e.g., the water-faring vessel 1 docks and the passenger gets off the water-faring vessel 1), or the passenger gets wet (e.g., swimming in a pool on the water-faring vessel 1), the tracking device is deactivated.

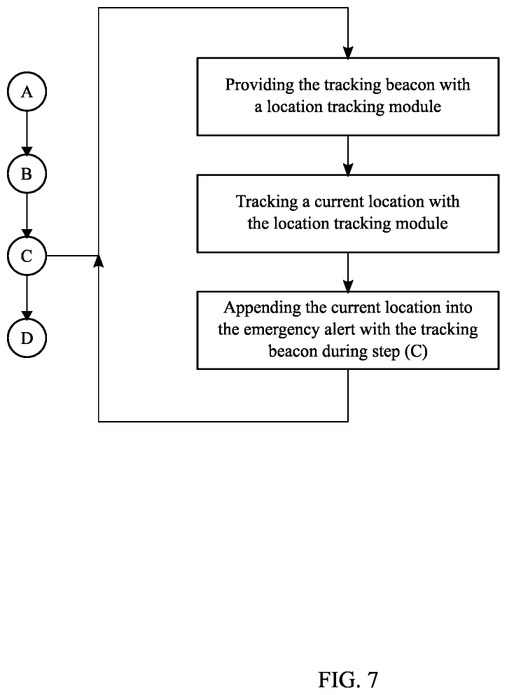

To improve the accuracy of the location tracking capabilities of the present invention, the tracking beacon 2 is further provided with a location tracking module 5. As can be seen in FIGS. 1 through 3 and 7, the location tracking module 5 helps the tracking beacon 2 generate more accurate location data that can be used by the central computing device 7 to better track the location of the passenger wearing the tracking beacon 2 around the water-faring vessel 1. To do so, the subprocess of generating more accurate location data involves tracking a current location with the location tracking module 5. The tracking of the current location of the tracking beacon 2 can be done continuously or at predetermined intervals. Then, the current location is appended into the emergency alert with the tracking beacon 2 during the Step C. This way, when the passenger wearing the tracking beacon 2 falls overboard from the water-faring vessel 1, the rescue parties can locate the overboard passenger faster instead of having to visually determine where the passenger has fallen off from the water-faring vessel 1. In addition, the location tracking module 5 can help the vessel staff find the location of any passenger during other emergency situations, such as trying to find a missing child.

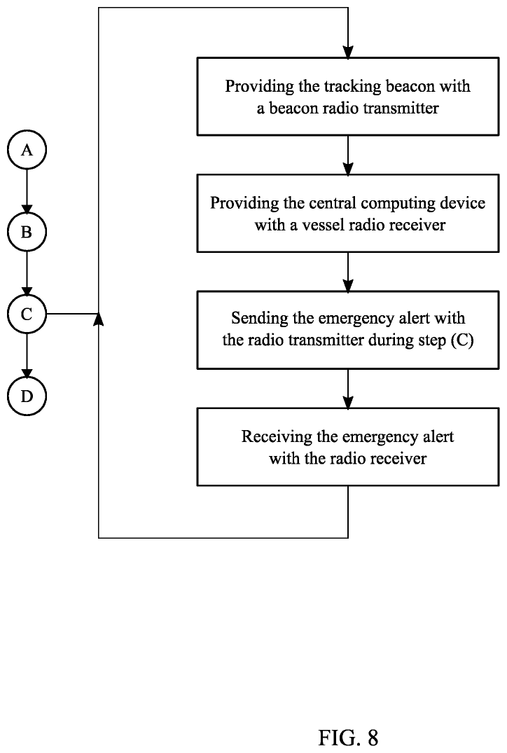

As previously disclosed, the present invention enables long-range tracking of the overboard passenger so that the overboard passenger can be rescued even in harsh weather conditions. As can be seen in FIGS. 1 through 3 and 8, to do so, the tracking beacon 2 is further provided with a beacon radio transmitter 6, and the central computing device 7 is provided with a vessel radio receiver 8. The beacon radio transmitter 6 and the vessel radio receiver 8 enable the emergency alert to be reliably transmitted via radio signals over long distances without risk of the emergency alert not being picked up by the central computing device 7. The subprocess of transmitting the emergency alert radio signal involves first sending the emergency alert with the beacon radio transmitter 6 during the Step C. Then, the emergency alert is received with the vessel radio receiver 8 to be processed by the central computing device 7. By utilizing radio technology to transmit the emergency alert, the present invention ensures that the overboard passenger wearing the tracking beacon 2 is found even if the overboard passenger starts to drift away from the water-faring vessel 1. Further, the emergency alert is preferably sent and received as a 418-megahertz (MHz) radio signal. However, other radio frequencies can be utilized.

Due to the multiple features provided in the tracking beacon 2, the tracking beacon 2 can be provided in different configurations according to the requirements of the water-faring vessel 1, as can be seen in FIG. 1 through 3. For example, the tracking beacon 2 can be integrated into a Personal Floatation Device (PFD), such as a life jacket. In the PFD embodiment, the beacon radio transmitter 6 can be integrated into the portion of the PFD that remains above water while the hydrostatic sensor 4 and the IMU module 3 can be integrated into the portions of the PFD that are submerged. In another embodiment, the tracking beacon 2 can be provided as a wearable device that can be easily attached to different clothing articles using an attachment mechanism such as a clip. In the wearable embodiment, the beacon radio transmitter 6 is provided with a clip so that the beacon radio transmitter 6 is worn adjacent to the shoulders of the passenger. The IMU module 3 and the hydrostatic sensor 4 can be provided on a separate housing with a clip so that both can be worn adjacent to the hip of the passenger. This way, when the passenger falls overboard, the beacon radio transmitter 6 remains above water while the IMU module 3 and the hydrostatic sensor 4 are submerged under water. In both the PFD embodiment and the wearable embodiment, the beacon radio transmitter 6 can be electronically connected to the IMU module 3 and the hydrostatic sensor 4. Alternatively, the beacon radio transmitter 6 can be communicably coupled with the IMU module 3 and the hydrostatic sensor 4. Furthermore, in both the PFD embodiment and the wearable embodiment, the tracking beacon 2 can be provided with a power switch that can be manually engaged to activate the tracking beacon 2. Alternatively, the power switch can be provided as an automatic switch that activates the tracking beacon 2 once the IMU module 3 and/or the hydrostatic sensor 4 activated during the Step B.

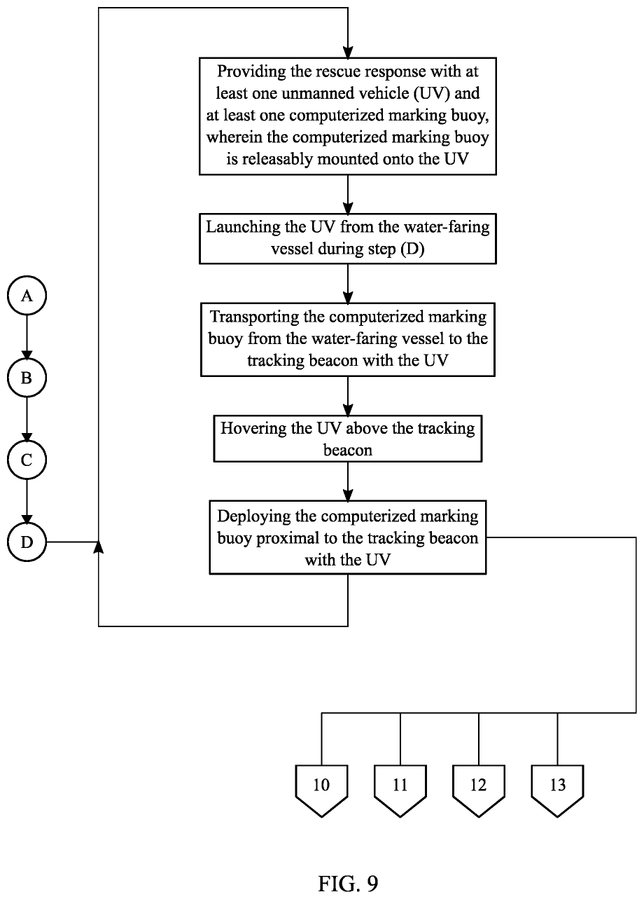

Tracking and locating the overboard passenger in harsh conditions can be difficult. For example, low-light conditions such as during the night or under heavy rain can make visual searches almost impossible. As can be seen in FIGS. 1, 4, and 9, to help rescue parties to track and locate the overboard passenger wearing the tracking beacon 2, the rescue response is provided with at least one unmanned vehicle (UV) 9 and at least one computerized marking buoy 12. The UV 9 and the computerized marking buoy 12 help the rescue parties remotely track, locate, and mark the overboard passenger using the emergency alert before fully deploying the rescue parties. This is especially helpful during harsh weather conditions when deploying the rescue parties without accurately locating the overboard passenger can risk the safety of the rescue parties. The computerized marking buoy 12 is preferably releasably mounted onto the UV 9 so that the computerized marking buoy 12 is transported by the UV 9. However, the computerized marking buoy 12 can include integrated transportation means so that the computerized marking buoy 12 can be deployed independent from the UV 9. Further, the UV 9 can be provided in different configurations to operate under different conditions. For example, the UV 9 can be provided as an unmanned aerial vehicle (UAV) or as an unmanned surface vehicle (USV). The UAV can help provide a better visual on the overboard passenger but may be ineffective in harsh weather conditions. On the other hand, the USV can operate better under harsh weather conditions. Furthermore, the UV 9 can be provided as an aerial drone or as a blimp, or a combination thereof.

As can be seen in FIGS. 1, 4, and 9, the subprocess of executing the rescue response using the UV 9 and the computerized marking buoy 12 starts by launching the UV 9 from the water-faring vessel 1 during the Step D. After the UV 9 has been launched, the computerized marking buoy 12 is transported from the water-faring vessel 1 to the tracking beacon 2 with the UV 9. After the UV 9 reaches the location of the overboard passenger wearing the tracking beacon 2, the UV 9 hovers above the tracking beacon 2. Then, the computerized marking buoy 12 is deployed proximal to the tracking beacon 2 with the UV 9. By keeping the UV 9 and the computerized marking buoy 12 close to the overboard passenger, the rescue parties can have a better visual on the overboard passenger and more accurate location information. Even in harsh weather conditions, the UV 9 can return to the water-faring vessel 1, but the computerized marking buoy 12 remains close to the overboard passenger to facilitate the rescue of the overboard passenger.

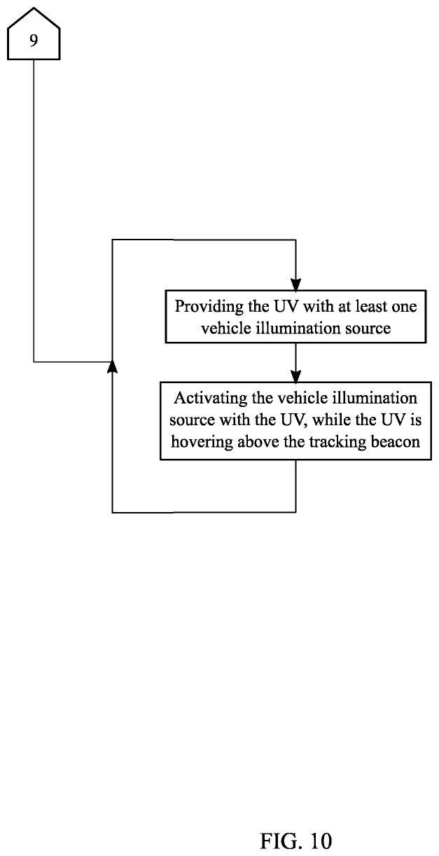

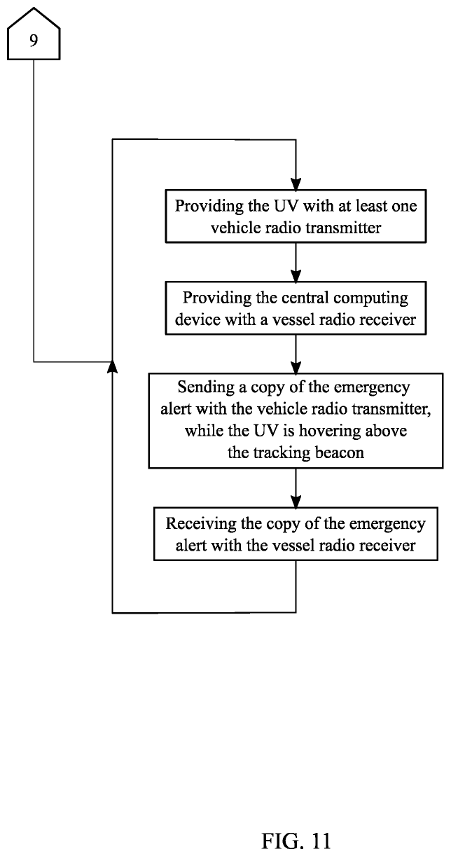

In order to help the rescue parties visually locate the overboard passenger during the rescue response, the UV 9 is provided with at least one vehicle illumination source 10. As can be seen in FIGS. 1, 4, 10, and 11, the vehicle illumination source 10 helps the rescue parties visually locate the overboard passenger by illuminating the overboard passenger. The subprocess of illuminating the overboard passenger starts by activating the vehicle illumination source 10 with the UV 9, while the UV 9 is hovering above the tracking beacon 2. The vehicle illumination source 10 can emit light in different wavelengths so that the visual tracking of the overboard passenger can occur under any light condition. In addition to the vehicle illumination source 10, the UV 9 is provided with at least one vehicle radio transmitter 11 so that the UV 9 is able to transmit radio signals regarding the location of the overboard passenger in case the tracking beacon 2 signal is not strong enough to do so. The subprocess of the UV 9 radio signal transmission starts by sending a copy of the emergency alert with the vehicle radio transmitter 11, while the UV 9 is hovering above the tracking beacon 2. The copy of the emergency alert is then received with the vessel radio receiver 8 so that the rescue parties can accurately locate the overboard passenger. Further, the copy of the emergency alert is preferably sent and received as a 406-MHz radio signal, a 418-MHz radio signal, and a X-band radio signal. This way, the rescue parties are able to accurately track the location of the overboard passenger visually and remotely during the rescue response.

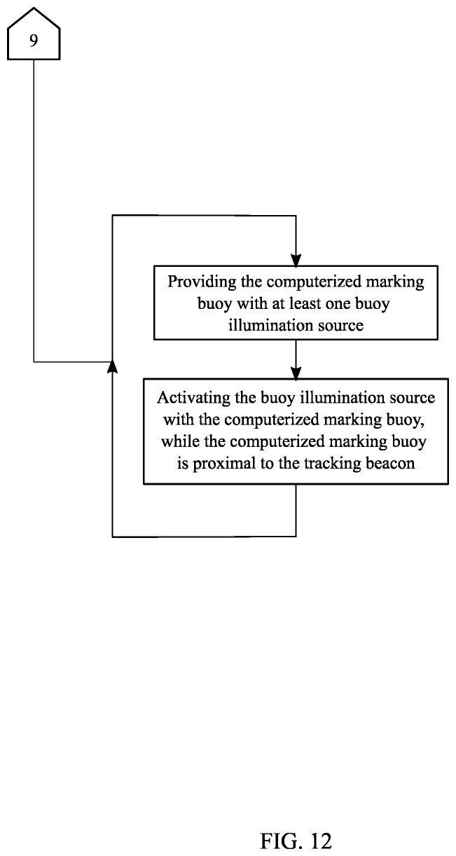

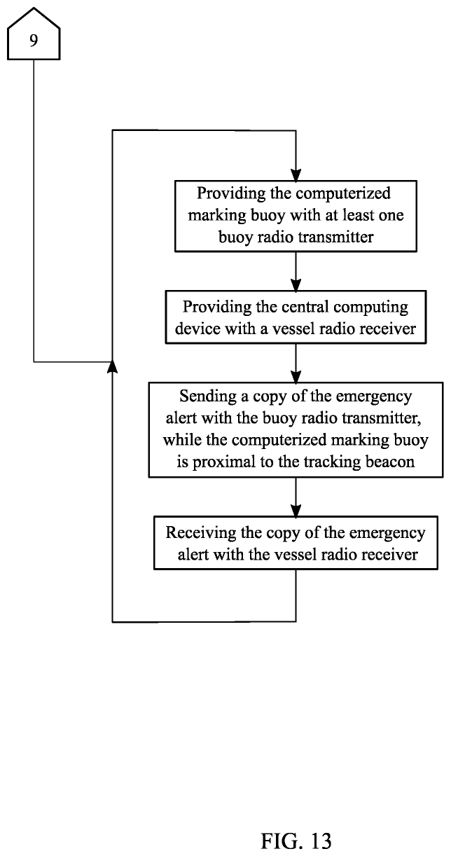

In case that the UV 9 is not able to remain hovering above the overboard passenger, the computerized marking buoy 12 can also be equipped with the same illumination and radio capabilities of the UV 9. As can be seen in FIGS. 1, 4, 12, and 13, to do so, the computerized marking buoy 12 is provided with at least one buoy illumination source 13. The buoy illumination source 13 helps illuminate the area surrounding the overboard passenger wearing the tracking beacon 2 to provide a better visual for the rescue parties to locate the overboard passenger. The subprocess of illuminating the overboard passenger starts by activating the buoy illumination source 13 with the computerized marking buoy 12, while the computerized marking buoy 12 is proximal to the tracking beacon 2. To be able to transmit radio signals, the computerized marking buoy 12 is provided with at least one buoy radio transmitter 14. Then, the subprocess of the computerized marking buoy 12 radio signal transmission starts by sending a copy of the emergency alert with the buoy radio transmitter 14, while the computerized marking buoy 12 is proximal to the tracking beacon 2. The copy of the emergency alert is then received with the vessel radio receiver 8. This way, the tracking beacon 2 is able to maintain radio communication with the central computing device 7 through the UV 9 or the computerized marking buoy 12. Further, similar to the UV 9, the copy of the emergency alert generated by the buoy radio transmitter 14 is sent and received as a 406-MHz radio signal, a 418-MHz radio signal, and a X-band radio signal. In other embodiments, the copy of the emergency alert can be sent and received over different radio frequencies.

Although the invention has been explained in relation to its preferred embodiment, it is to be understood that many other possible modifications and variations can be made without departing from the spirit and scope of the invention.

What is claimed is:

1. A method of detecting and notifying of an occurrence of an overboard passenger on a vessel, the method comprising the steps of:
(A) providing a water-faring vessel, at least one tracking beacon, at least one central computing device, wherein the central computing device is mounted onto the water-faring vessel, and wherein the tracking beacon is initially set with an onboard status while the tracking beacon is located onboard the water-faring vessel;
(B) resetting the tracking beacon from the onboard status to an overboard status, if the tracking beacon is located overboard the water-faring vessel;
(C) transmitting an emergency alert from the tracking beacon to the central computing device, if the tracking beacon is set to the overboard status; and,
(D) executing at least one rescue response with the central computing device.

2. The method as claimed in claim 1 comprising the steps of:
providing the tracking beacon with an inertial measurement unit (IMU) module and a hydrostatic sensor;
tracking spatial-positioning and orientation data with the IMU module; and,
designating the tracking beacon as overboard the water-faring vessel during step (B), if an overboard falling event is identified within the spatial-positioning and orientation data, and if a water submersion event is detected by the hydrostatic sensor.

3. The method as claimed in claim 1 comprising the steps of:
providing the tracking beacon with a location tracking module;
tracking a current location with the location tracking module; and,
appending the current location into the emergency alert with the tracking beacon during step (C).

4. The method as claimed in claim 1 comprising the steps of:
providing the tracking beacon with a beacon radio transmitter;
providing the central computing device with a vessel radio receiver;
sending the emergency alert with the beacon radio transmitter during step (C); and,
receiving the emergency alert with the vessel radio receiver.

5. The method as claimed in claim 4, wherein the emergency alert is sent and received as a 418-megahertz (MHz) radio signal.

6. The method as claimed in claim 1 comprising the steps of:
providing the rescue response with at least one unmanned vehicle (UV) and at least one computerized marking buoy, wherein the computerized marking buoy is releasably mounted onto the UV;
launching the UV from the water-faring vessel during step (D);
transporting the computerized marking buoy from the water-faring vessel to the tracking beacon with the UV;
hovering the UV above the tracking beacon; and,
deploying the computerized marking buoy proximal to the tracking beacon with the UV.

7. The method as claimed in claim 6 comprising the steps of:
providing the UV with at least one vehicle illumination source; and,
activating the vehicle illumination source with the UV, while the UV is hovering above the tracking beacon.

8. The method as claimed in claim 6 comprising the steps of:
providing the UV with at least one vehicle radio transmitter;
providing the central computing device with a vessel radio receiver;
sending a copy of the emergency alert with the vehicle radio transmitter, while the UV is hovering above the tracking beacon; and,
receiving the copy of the emergency alert with the vessel radio receiver.

9. The method as claimed in claim 8, wherein the copy of the emergency alert is sent and received as a 406-MHz radio signal, a 418-MHz radio signal, and a X-band radio signal.

10. The method as claimed in claim 6 comprising the steps of:
providing the computerized marking buoy with at least one buoy illumination source; and,
activating the buoy illumination source with the computerized marking buoy, while the computerized marking buoy is proximal to the tracking beacon.

11. The method as claimed in claim 6 comprising the steps of:
providing the computerized marking buoy with at least one buoy radio transmitter;
providing the central computing device with a vessel radio receiver;
sending a copy of the emergency alert with the buoy radio transmitter, while the computerized marking buoy is proximal to the tracking beacon; and,
receiving the copy of the emergency alert with the vessel radio receiver.

12. The method as claimed in claim 11, wherein the copy of the emergency alert is sent and received as a 406-MHz radio signal, a 418-MHz radio signal, and a X-band radio signal.

13. The method as claimed in claim 6, wherein the UV is an aerial drone.

14. The method as claimed in claim 6, wherein the UV is a blimp.
